(19) United States
(12) Patent Application Publication
(10) Pub. No.: US 2007/0024875 A1
(43) Pub. Date: Feb. 1, 2007

(54) User terminal device, and a system and method for setting a borderless function

(75) Inventor: Myoung-jin Oh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/492,037

(22) Filed: Jul. 25, 2006

(30) Foreign Application Priority Data
Jul. 27, 2005 (KR) 2005-68220

(51) Int. Cl. G06K 15/00

(52) U.S. Cl. 358/1.2; 358/1.9; 358/1.14

(57) ABSTRACT

A user terminal device implemented with a system for and method of setting a borderless function includes an object extracting part extracting the object including font and image from the data to be printed; a driver creating printing data by either enlarging or reducing the image corresponding to the paper size, and resetting the font location, out of the extracted objects; and an interfacing part of an image forming apparatus transmitting the created printing data to the image forming apparatus. Accordingly, a font is prevented from being distorted when the borderless function is applied.

### CROSS-REFERENCE TO RELATED APPLICATION

This application claims the benefit under 35 U.S.C. § 119(a) of Korean Patent Application No. 2005-68220, filed Jul. 27, 2005 in the Korean Intellectual Property Office, the disclosure of which is incorporated herein by reference.

### BACKGROUND OF THE INVENTION

1. Field of the Invention

Aspects of the present invention relate to a user terminal device, and a system and method for setting a borderless function, and more particularly, to a user terminal device, and a system and method for setting a borderless function in order to prevent font distortion.

2. Description of the Related Art

As digital technology develops, digital imaging apparatuses such as a digital camera and a digital camcorder have been widely used. As such, there has emerged a printer exclusively for an image with an improved picture quality. Accordingly, there is an increasing desire to store images photographed by a digital imaging apparatus on a storing medium, such as a hard disc drive of a computer, and printing the digital image on paper in person without requesting a special film laboratory to print the image.

The printer exclusively for an image may be a printer for a digital photo printing images stored at the digital imaging apparatus connected by a PictBridge or a mobile storing medium. The printer exclusively for an image can print photos of a similar quality to general film photo by use of photo paper. The printer exclusively for an image has various additional functions for printing the image that are in addition to functions provided from a conventional image forming apparatus. One example may be a borderless function that automatically fits the image to the paper size to make the best use of the paper. The borderless function is such that, even if a user does not set the size, the image forming apparatus enlarges an original image to not to leave any unused space on the paper.

FIGS. 1A and 1B show a result with a conventional borderless function applied. FIG. 1A is a print without a borderless function applied, where the size of the original image is indicated by the dashed lines and is a bit smaller than the paper. Thus, the original image shown in FIG. 1A leaves a space on the paper due to differences in size between the original image and the paper size. FIG. 1B is an example of the print with the borderless function applied. As illustrated in FIGS. 1A and 1B, the original image shown in FIG. 1A includes a picture and a font. When the original image is enlarged to fit to the paper as shown in FIG. 1B, the picture has no problem, while the font is distorted.

In applying the borderless function, the conventional image forming apparatus re-designates the location and the size, as illustrated in FIGS. 1A and 1B, and enlarges the bitmap (such as a BMP format) of the image by 1 bit. Because a decimal point is lost in the font size information when the bitmap is enlarged by 1 bit, the font is not uniformly magnified, as illustrated in FIG. 1B. Accordingly, the font is distorted.

### SUMMARY OF THE INVENTION

Aspects of the present invention provide a user terminal device and a system for and method of setting a borderless function, capable of enlarging an image of data to be printed but resetting font location only, when a borderless function is used.

According to an aspect of the invention, a user terminal device for setting a borderless function includes an object extracting part extracting the object including font and image from the data to be printed; a driver creating printing data by either enlarging or reducing the image corresponding to the paper size, and resetting the font location, out of the extracted objects; and an interfacing part of an image forming apparatus transmitting the created printing data to the image forming apparatus.

According to an aspect of the invention, the object extracting part is a Graphic Device Interface (GDI).

According to an aspect of the invention, the driver comprises an image scaling part either enlarging or reducing the image corresponding to the paper size, a font properties extracting part extracting a font properties including font location information, and a driver controlling part resetting the font location based on the extracted location information and creating the printing data, using the changed image and the location-reset font.

According to an aspect of the invention, the location information extracted by the font properties extracting part includes column value and row value of each font.

According to an embodiment of the present invention, the method of setting a borderless function includes extracting the object including the font and the image from the data to be printed; either enlarging or reducing the image out of the extracted objects corresponding to the paper size; resetting the location of the font, out of the extracted objects; creating the printing data, using the changed image and the location-reset font; and transmitting the created printing data to the image forming apparatus.

According to an aspect of the invention, the resetting the location of the font comprises extracting the font properties including the font location information; and resetting the font location based on the extracted location information.

According to an aspect of the invention, the location information comprises the column value and the row value of each font.

According to an embodiment of the present invention, a system for setting a borderless function comprises: a user terminal device extracting an object including a font and an image from data to be printed, and creating printing data by enlarging the image corresponding to the paper size and resetting location of the font, out of the extracted objects; and the image forming apparatus receiving the printing data from the user terminal device and printing the received printing data.

According to an aspect of the invention, the user terminal device comprises: an object extracting part extracting an object including a font and an image from data to be printed; a driver creating printing data by either enlarging or reducing the image corresponding to the paper size, and resetting a font location, out of the extracted objects; and an interfacing part of an image forming apparatus transmitting the created printing data to the image forming apparatus.

According to an aspect of the invention, the object extracting part is a Graphic Device Interface (GDI).

According to an aspect of the invention, the driver comprises an image scaling part either enlarging or reducing the image corresponding to the paper size, a font properties extracting part extracting including font location information, and a driver controlling part resetting the font location based on the extracted location information and creating the printing data, using the changed image and the location-reset font.

Additional aspects and/or advantages of the invention will be set forth in part in the description which follows and, in part, will be obvious from the description, or may be learned by practice of the invention.

### BRIEF DESCRIPTION OF THE DRAWINGS

The above and other aspects and/or advantages and features of the present invention will become more apparent and more readily appreciated by describing in detail exemplary embodiments thereof with reference to the accompanying drawing figures, wherein;

FIGS. 1A and 1B show a result with a conventional borderless function applied;

FIG. 2 is a block diagram of a user terminal device for setting a borderless function according to an embodiment of the present invention;

FIGS. 3A and 3B show a result with an applied borderless function according to an embodiment of the present invention; and

FIG. 4 is a flowchart provided to explain a method of setting the borderless function according to an embodiment of the present invention.

### DETAILED DESCRIPTION OF THE EMBODIMENTS

Hereinafter, embodiments of the present invention will be described in detail with reference to the accompanying drawing figures. In the following description, like reference numerals are used for the like elements. The matters defined in the description such as a detailed construction and elements are limited to the ones provided to assist in a comprehensive understanding of the invention. Thus, it is apparent that the present invention can be carried out without those defined matters known to one skilled in the art. Therefore, well-known functions or constructions are not described in detail since this description would obscure the invention in unnecessary detail without improving comprehension.

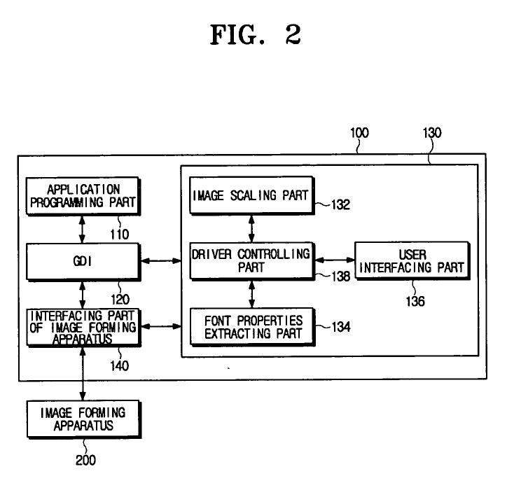

FIG. 2 is a block diagram of a user terminal device for setting a borderless function according to an embodiment of the present invention. Referring to FIG. 2, a user terminal device 100 for setting the borderless function includes an application programming part 110, an object extracting part, a driver 130 and an interfacing part 140 which interfaces with an image forming apparatus 200. The application programming part 110 gives a command for printing data to be printed. The application programming part 110 performs an interface with the driver 130 of the image forming apparatus 200, through a Graphic Device Interface 120 (GDI), corresponding to a user input signal. While shown as separate, it is understood that the user terminal device 100 can be included in the image forming apparatus 200.

Additionally, the application program 110 includes programs which create objects with combined images and symbols. While not limited thereto, examples of the programs 100 which output such objects include word processing programs, presentation programs, photo-album programs, and graphics programs.

The object extracting part receives data to be printed from the application programming part 110, extracts objects included in the data to be printed and provides the extracted objects to the driver 130. The shown object extracting part is the GDI 120. The GDI 120 is a part of a MICROSOFT WINDOWS operating system used for a computer operating system, and supports the interface between the application programming part 110 and the driver 130. For example, the GDI 120 transmits to the driver 130 the command for printing and data to be printed which are transmitted from the application programming part 110. However, it is understood that the object extracting part can be other devices and/or standards which represent graphical objects to be output to the image forming apparatus 200 and can be implemented using similar functionalities resident in other operating systems.

The GDI 120 extracts respective objects included in the data to be printed which is transmitted from the application programming part 110. The GDI 120 transmits the extracted objects to the driver 130. That is, because the data to be printed includes fonts and images within the objects, the GDI 120 extracts the fonts and the images and transmits the extracted fonts and images to the driver 130.

The driver 130 is a driver program for controlling the image forming apparatus 200. The driver 130 converts the data to be printed which is input from the application programming part 110 through the GDI 120 into data recognizable at the image forming apparatus 200. The driver 130 enlarges and/or reduces the extracted image to a size corresponding to the paper size. The driver 130 resets a font location for the font. The driver 120 creates the printing data using the changed image and the location-reset font. The shown driver 130 includes the image scaling part 132, a font properties extracting part 134, a user interfacing part 136, and a driver controlling part 138. However, it is understood that the driver 130 can be otherwise implemented. Moreover, while described as a driver, it is understood that the driver 130 can be any program which receives data not formatted to be output on a specific device and which transforms the received data to be output on the specific device. Also, while described as receiving the object from only one application programming part 110, it is understood that the driver 130 can be configured to interface with a plurality of application programs on or connected to the device 100 so as to be program independent.

The shown image scaling part 132 enlarges and/or reduces the image separately from the font. The image is scaled to correspond to the paper size. The image scaling part 132 performs a borderless function for the image, and enlarges and/or reduces the image to not to leave any space on the paper where the image is printed. That is, the image scaling part 132 enlarges the image when the image is smaller than the paper, while the image scaling part 132 reduces the image when the image is bigger than the paper.

The font properties extracting part 134 extracts the font properties out of the objects extracted from the GDI 120. The font properties may include, but are not limited to, location information (such as column value and row value), and size (such as height, width and 1-bit real bmp) or combinations thereof.

The user interfacing part 136 basically provides menus for setting printing options such as paper setting, printing quality, and the number of paper to be printed, in order to control the image forming apparatus 200. Additionally, the user interfacing part 136 further offers menus allowing to select whether to set a borderless function, or not. However, it is understood that the interfacing part 136 need not be used in all aspects, or can have other functionalities.

The driver controlling part 138 controls an overall function of the driver 130. Signals are input and output between the image scaling part 132, the font properties extracting part 134, and the user interfacing part 136, under the control of the driver controlling part 138. The driver controlling part 138 resets the font location, based on the font location information extracted by the font properties extracting part 134 in order to account for the enlarged image scaled by the image scaling part 132. The driver controlling part 138 creates the printing data recognizable at the image forming apparatus 200 by the image enlarged and/or reduced by the image scaling part 132, and the location-reset font reset by the controlling part 138. By way of example, the reset location includes a new column value and/or a row value of each font relative to the resized image the values relative to the original image. While described as adjusting the font location, it is understood that the driver controlling part 138 can also adjust other font properties detected by the font properties extracting part 134 in addition to or instead of the font location.

The interfacing part 140 of the image forming apparatus supports the interface between the user terminal device 100 and the image forming apparatus 200. The printing data created at the driver controlling part 138 is transmitted to the image forming apparatus 200 through the interfacing part 140 of the image forming apparatus 200. The image forming apparatus 200 is connected to the user terminal device 100 in a predetermined wired and/or wireless way, and/or receives the printing data transmitted from the user terminal device 100, and prints in a usual way.

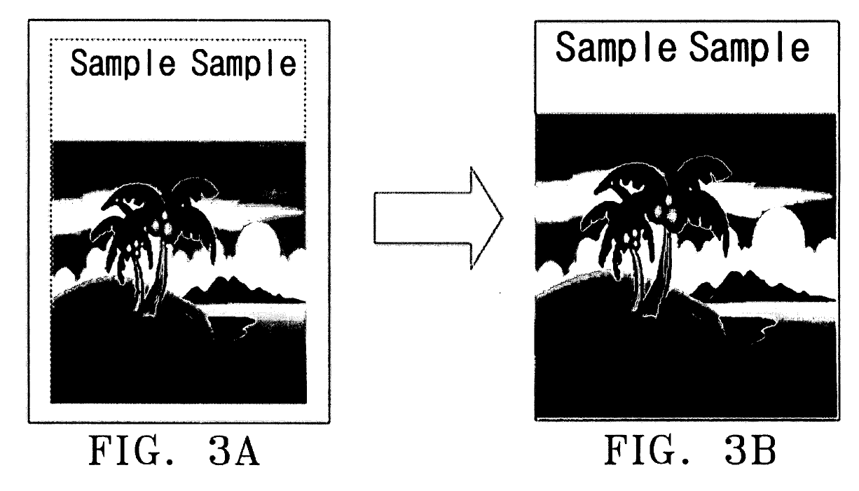

FIGS. 3A and 3B show a result with an applied borderless function according to an embodiment of the present invention. FIG. 3B is a result of application of the borderless function according to the embodiment of the present invention. As illustrated in FIG. 3A, the data to be printed is smaller than the printing paper and accordingly, leaves space outside the dotted data to be printed on the paper. According to the embodiment of the present invention, the data to be printed is enlarged not to leave on the paper any space caused by differences in size between the data to be printed and the paper, as illustrated in FIG. 3B.

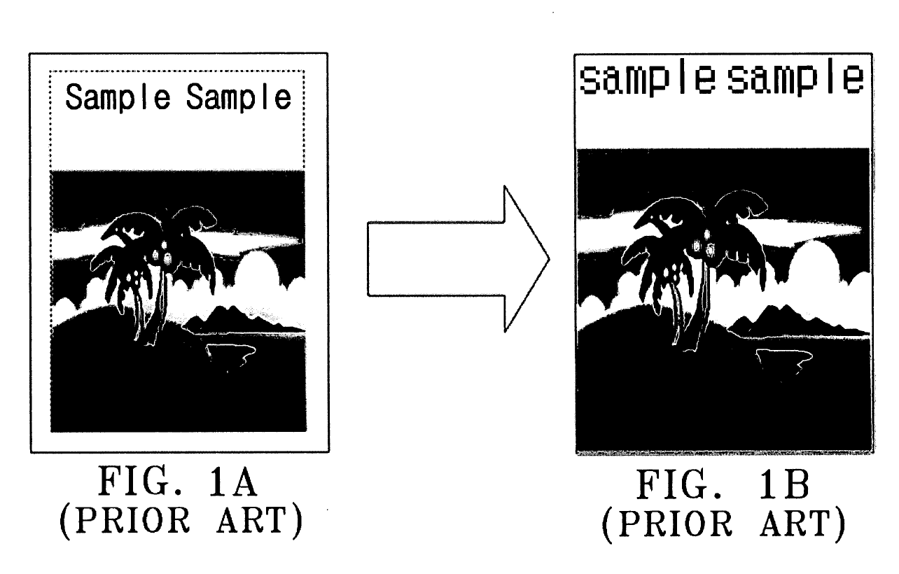

The image scaling part 132 enlarges and/or reduces the image of the data to be printed corresponding to the paper size. The driver controlling part 138 resets the font location using the properties extracted by the font properties extracting part 134, without either enlarging or reducing the font size. FIG. 3B is created as a result. Comparing FIGS. 3B and 1B, the image is either enlarged or reduced corresponding to the paper size, while the font is reset for the location. Accordingly, the font distortion does not occur by the font enlargement. However, it is understood that the font can be enlarged or reduced according to or instead of the reset location in other aspects of the invention.

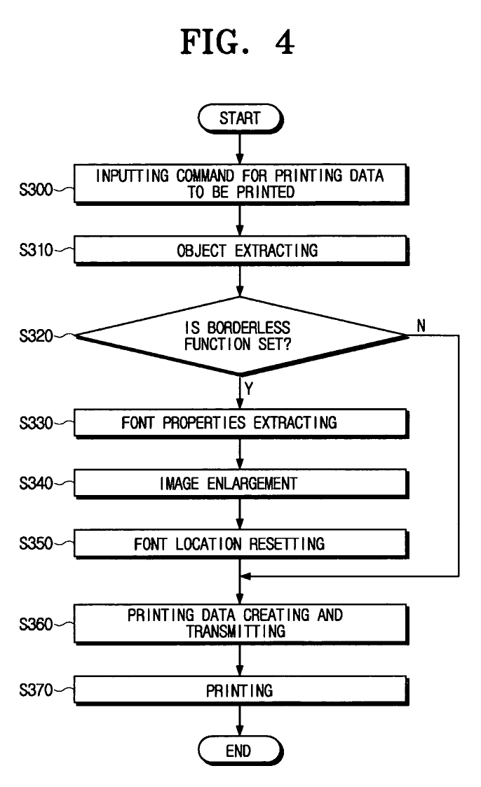

FIG. 4 is a flowchart provided to explain a method of setting the borderless function according to the embodiment of the present invention. While not required, aspects of the method can be implemented using one or more computer readable media readable by one or more computers.

Referring to FIGS. 2 and 4, detailed is the method of setting the borderless function according to the embodiment of the present invention, with a case exemplified that the image is smaller than the paper. A command is given for printing the data to be printed corresponding to the user input signal from the application programming part 110. The data to be printed and the command for printing are input to the GDI 120 from the application programming part 110 (S300).

When the data to be printed and the command for printing are input from the application programming part 110, the GDI 120 extracts each object included in the data to be printed. The objects include the font and the image. Each object extracted by the GDI 120 are input to the driver 130 (S310). When the objects are input from the GDI 120, the driver controlling part 138 determines whether the borderless function is set by the user input signal. The borderless function may be set by menus provided from the user interfacing part 136, but can be otherwise indicated or had as a default setting (S320).

When it is determined that the borderless function is set in S320, the driver controlling part 138 provides the font out of the objects input from the GDI 120 to the font properties extracting part 134. The font properties extracting part 134 extracts the font properties (S330). The driver controlling part 138 provides the image out of the objects input from the GDI 120 to the image scaling part 132. The image scaling part 132 enlarges the image corresponding to the paper (S340). The driver controlling part 138 resets the font location, using the location information out of the font properties extracted by the font properties extracting part 134 (S350). The reset location accounts for the enlarged and/or reduced image's new size.

The printing data are created by the location-reset font and the image enlarged by the image scaling part 132. The driver controlling part 138 controls the interfacing part 140 of the image forming apparatus to transmit the created printing data to the image forming apparatus 200. The printing data are transmitted to the image forming apparatus 200 through the interfacing part 140 of the image forming apparatus (S360).

The image forming apparatus 200 receives the printing data transmitted from the user terminal device 100 and prints (S370). If it is determined that the borderless function is not set in S320, the image is not needed to enlarge. Accordingly, the driver controlling part 138 uses the objects extracted from the GDI 120, as they are, to create the printing data.

As abovementioned, high quality prints are provided even if the borderless function is applied, by enlarging only images without distortion out of images and fonts included in the data to be printed in order not to leave any spaces on the paper, and resetting locations for only fonts with distortion in enlargement without changing the size.

A user terminal device, and a system for and method of setting a borderless function according to an embodiment of the present invention, prevent font distortions caused from size magnification, by either enlarging or reducing the image size, and resetting font location, when the borderless function is applied, accordingly improving picture quality of the prints. While described in the context of prints on paper, it is understood that aspects of the present invention can be used in other non-paper media or virtual media on which images and writing are formed.

While the invention has been shown and described with reference to certain embodiments thereof, it will be understood by those skilled in the art that various changes in form and details may be made therein without departing from the spirit and scope of the invention as defined by the appended claims and equivalents thereof.

What is claimed is:

1. A user terminal device for setting a borderless function comprising:
an object extracting part to extract an object from data to be printed on an image forming apparatus, the extracted object including a font and an image;
a driver to create printing data from the extracted object by enlarging and/or reducing the image to correspond to a paper size, and resetting a font location of the font; and
an interfacing part to transmit to the image forming apparatus the created printing data to the image forming apparatus.

2. The user terminal device of claim 1, wherein the object extracting part comprises a Graphic Device Interface (GDI).

3. The user terminal device of claim 1, wherein the driver comprises:
an image scaling part to enlarge and/or reduce the image to correspond to the paper size;
a font properties extracting part to extract from the object a font properties including font location information; and
a driver controlling part to reset the font location based on the extracted font location information and to create the printing data using the enlarged and/or reduced image and the reset font location.

4. The user terminal device of claim 3, wherein the location information extracted by the font properties extracting part includes a column value and/or a row value of each font.

5. A method of setting a borderless function comprising:
extracting an object including a font and an image from data to be printed;
enlarging and/or reducing the image from the extracted object to correspond to a paper size;
resetting a location of the font from the extracted object;
creating printing data using the enlarged and/or reduced image and a reset font location; and
transmitting the created printing data to an image forming apparatus to be printed on a paper having the paper size.

6. The method of claim 5, wherein the resetting the location of the font comprises:
extracting at least one of a plurality font properties including font location information; and
resetting the font location based on the extracted font location information.

7. The method of claim 6, wherein the font location information comprises a column value and/or row value of each font.

8. A system for setting a borderless function comprising:
a user terminal device to extract an object including a font and an image from data to be printed, and to create printing data by enlarging and/or reducing the image to correspond to a paper size and resetting a font location; and
an image forming apparatus to receive the created printing data from the user terminal device and to print the received printing data on a paper having the paper size.

9. The system of claim 8, wherein the user terminal device comprising:
an object extracting part to extract the object including the font and the image from the data to be printed;
a driver to create the printing data by enlarging and/or reducing the image to correspond to the paper size, and to reset the font location from the extracted object; and
an interfacing part of an image forming apparatus transmitting the created printing data to the image forming apparatus.

10. The system of claim 9, wherein the object extracting part is a Graphic Device Interface.

11. The system of claim 9, wherein the driver comprises:
an image scaling part enlarges and/or reduces the image to correspond to the paper size;
a font properties extracting part to extract font properties including the font location information; and
a driver controlling part to reset the font location based on the extracted font location information and to create the printing data using the enlarged and/or reduced image and the reset font location.

12. An object resizing device for use with original data for a document of a first size into resized data for a document of a second size other than the first size, comprising:
an image resizing part to resize an image within the original data to have another image size corresponding to the second size; and
a font adjusting part to adjust a font location of a font within the original data to have an adjusted font location within the resized data according to the resized image.

13. The object resizing device of claim 12, further comprising a controlling part which creates the resized data including the resized image and the font at the adjusted font location relative to the image, and sends the resized data as printer data formatted to be printed at a printing device.

14. The object resizing device of claim 12, wherein the second size corresponds to a document with substantially no border to as to equal a size of a medium on which the resized printer data is printed, and the first size corresponds to a document with a border and which is substantially less than the size of the medium.

15. The object resizing device of claim 14, wherein a font size of the font in the resized printer data is not changed as compared to the font size in the original printer data.

16. The object resizing device of claim 14, wherein a change in font size of the font in the resized printer data is not equal to a change in image size to the another image size.

17. The object resizing device of claim 12, further comprising a printer driver program including the object resizing device, wherein the original data comprises original printer data produced by an application program, and the resized data comprises resized printer data received at an image forming apparatus to be printed on a medium according to the printer driver program.

18. The object resizing device of claim 17, wherein the printer driver further comprises a controlling part which creates the resized printer data including the resized image and the font at the adjusted font location relative to the image, and sends the resized printer data formatted to be printed at the image forming apparatus.

19. The object resizing device of claim 18, wherein the controlling part interfaces with a graphical device interface through which the original printer data is received from the application program as image and font objects within the original printer data, and sends the resized printer data through an interface of the image forming apparatus.

20. The object resizing device of claim 18, further comprising a computer including the printer driver, wherein the controlling part interfaces with an operating system of the computer to receive the original printer data from the application program and uses an interface of the computer to output the resized printer data to the image forming apparatus.

21. The object resizing device of claim 17, wherein the second size corresponds to a document with substantially no border to as to equal a size of a medium on which the resized printer data is printed, and the first size corresponds to a document with a border and which is substantially less than the size of the medium.

22. The object resizing device of claim 17, wherein a font size of the font in the resized printer data is not changed.

23. The object resizing device of claim 17, wherein a change in font size of the font in the resized printer data is not equal to a change in image size to the another image size.

24. The object resizing device of claim 17, wherein the font location information includes a column value and/or a row value of each font in the resized printer data.

25. A computer readable medium encoded with a method of setting a borderless function implemented by at least one computer, the method comprising:
receiving a font object and an image object from data to be printed;
resizing an image in the image object to correspond to a second size;
resetting a location of a font in the font object according to the resized image; and
creating resized data to be printed using the resized image and the reset font location.
